(19) United States
(12) Patent Application Publication
(10) Pub. No.: US 2018/0005322 A1
(43) Pub. Date: Jan. 4, 2018

(54) METHOD FOR DISTRIBUTING SECURITIES SUCH AS SHARES OR BONDS, IN PARTICULAR OF COMPANIES SEEKING FUNDING, AND SYSTEM FOR IMPLEMENTING SAID METHOD

(71) Applicant: BOXCORP SA, Val Saint-Andre (LU)

(72) Inventors: Alexandre Azoulay, Paris (FR); Audrey Stewart, Paris (FR)

(21) Appl. No.: 15/539,258

(22) PCT Filed: Feb. 5, 2015
(86) PCT No.: PCT/FR2015/050274

§ 371 Date: Jun. 23, 2017

(30) Foreign Application Priority Data
Dec. 23, 2014 (FR) 1463271

(51) Int. Cl. G06Q 40/06; G06Q 20/10; G06Q 40/04

(52) U.S. Cl. CPC G06Q 40/06; G06Q 20/102; G06Q 40/04

(57) ABSTRACT

A method for distributing securities, such as shares or bonds, in particular of companies seeking funding. In the method, a platform is created for distributing the securities of companies seeking investors, the platform establishes groups of securities of one or more companies, each group of securities is presented in the form of a physical element constituting a product capable of being sold in a sales channel for consumer goods, while ensuring the legal arrangements for purchasing securities are observed.

### FIELD OF THE INVENTION

The invention relates to a method for distributing securities, such as shares or bonds, in particular of companies seeking funding, and a system for implementing this method.

### BACKGROUND

The sale of shares, for example, is relatively easy for companies that are known and attractive due to their reputation. Conversely, companies that are less or just starting out will encounter difficulties in finding investors.

The invention aims to propose a solution to this problem.

### SUMMARY OF THE INVENTION

To that end, the method according to the invention is characterized in that a platform is created for distributing shares, the platform establishes groups of shares, each group of shares is presented in the form of a physical element constituting a product capable of being sold in a sales channel for consumer goods, while ensuring that legal arrangements for purchasing securities are observed.

According to one feature of the invention, the method is characterized in that groups of securities of one or several companies are established.

According to another feature of the invention, the method is characterized in that groups of securities are established of one or several companies with a low financial value, of around one or several hundred euros.

According to still another feature of the invention, the method is characterized in that each group of securities is presented in the sales channel for consumer goods through a physical element such as a box, envelope or the like identified by a unique code.

According to still another feature of the invention, the method is characterized in that the physical element embodying a group of securities is made in the form of a three-dimensional element such as a box or envelope inside which at least the unique identification code for the three-dimensional element is found.

According to still another feature of the invention, the method is characterized in that the three-dimensional element further contains a booklet that includes a description of the companies whose shares are embodied by the three-dimensional element and the usage mode including an address for connecting to the website of the platform.

According to still another feature of the invention, the method is characterized in that the three-dimensional element contains at least one proposal for the composition of the group of securities.

According to still another feature of the invention, the method is characterized in that the access to the website of the platform opens, after entering the unique code, a subscription procedure for the securities, in order for the buyer of the three-dimensional element to confirm his purchase of the securities through his electronic signature.

According to still another feature of the invention, the method is characterized in that, during the subscription, the buyer must create an identifier and password and fill out the mandatory questionnaire according to the directives of the financial instruments market.

According to still another feature of the invention, the method is characterized in that the acquisition of the securities by the buyer of the physical element embodying the selected group of shares requires, in addition to the unique code of the physical element, an additional condition fulfilled by the act of paying for the physical element.

According to still another feature of the invention, the method is characterized in that the aforementioned second condition involves sending a validation signal to the platform when paying for the physical element.

According to still another feature of the invention, the method is characterized in that the aforementioned second condition involves a validation code that is given to the buyer of the three-dimensional element when paying for this element.

According to still another feature of the invention, the method is characterized in that the physical element is formed by a single-use box, made from an appropriate material, such as cardboard.

According to still another feature of the invention, the method is characterized in that the physical element is contained in a casing box and in that the buyer has access to the physical element by opening the casing box when payment is made.

According to still another feature of the invention, the method is characterized in that the casing box is made in the form of a smart box programmable and reprogrammable by the platform.

According to still another feature of the invention, the method is characterized in that the physical element is a two-dimensional element.

According to still another feature of the invention, the method is characterized in that the securities are shares.

According to still another feature of the invention, the method is characterized in that the sales circuit is a big box store.

The invention also relates to a system for carrying out the method as previously described, characterized in that it comprises a platform for distributing securities, suitable for establishing physical elements of securities in the form of products able to be displayed or sold in circuits and stores selling consumer goods, the physical elements, and the circuits and store for selling physical goods.

### BRIEF DESCRIPTION OF DRAWING FIGURES

The invention will be better understood, and other aims, features, details and advantages thereof will appear more clearly, in the following explanatory description done in reference to the appended drawings, provided solely as an example illustrating one embodiment of the invention and in which:

FIGS. 1 and 2 schematically show two steps of the sale of securities according to the inventive method, and

FIG. 3 shows an alternative of the steps of FIG. 2.

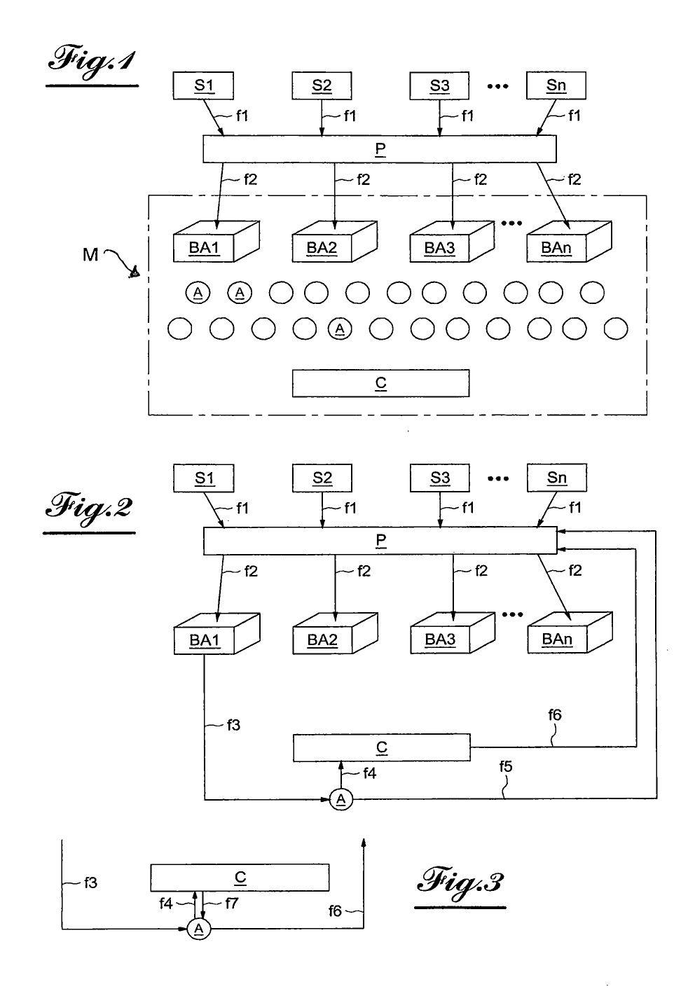

### DETAILED DESCRIPTION

The figures illustrate, by way of non-exclusive example, the diagram of one embodiment of a method and a system for distributing securities, in the case at hand shares, of a plurality of companies that are seeking funding by selling shares.

The particularity of the invention lies in the fact that it promotes the distribution of shares by displaying and selling them in the form of products able to be introduced into sales circuits or stores for consumer goods, and to be sold to customers visiting these circuits and this store. By promoting the offer of shares in circuits or stores of this type, the invention succeeds in reaching a large number of individuals who are not experienced or professional investors, on the one hand, and on the other hand, encourages these individuals to purchase shares with a relatively modest price of around a hundred euros, for example between 100 and 500 euros, preferably between 200 and 400 euros.

More specifically, as shown by the figures, one essential feature of the invention lies in the creation of a platform P for investment services, including the distribution of shares, to which a plurality of companies Si to Sn seeking investments through the sale of shares entrust the sale thereof. This platform offers companies a share distribution network by connecting these companies with a large audience of individual investors.

The platform establishes groups several shares, either of a single company, or of several companies, for example two or three, each with the relatively low monetary value set out above, i.e., around one or several hundred euros. The shares of each group are preferably selected based on a theme designating an industrial, economic or similar activity sector, such as ecology, biotechnology, Internet or mass consumption, a geographical area or a type of financial product.

According to another essential feature of the invention, each group of shares thus organized by theme will next be presented to the general public through an attractive physical element, advantageously a box BA1, BA2 to BAm that will be displayed in a circuit or store for the sale of [consumer] goods, advantageously a big box store, indicated in the figures by reference M. In the figures, reference A symbolizes the individuals, i.e., potential buyers, who are present in the store M and therefore pass in front of the displayed boxes, which show, on their outer faces, the theme of the shares embodied by the box and the amount of the shares, making up the price of the box.

Each box, for example made from cardboard, may contain a document such as a gift card in the amount of the price of the box, which has no face value, but bears a unique code designating the box, the code being used to subscribe for the capital of the companies, as will be explained later, and a booklet containing all of the companies whose shares are part of the group of shares embodied by the box. The booklet includes a description of the companies and user instructions to be able to invest in the companies. The user instructions include an address to connect to a website, in particular the platform P, with a unique subscription number, and a glossary of stock market terms. It should be noted that the boxes are closed.

Arrows f1 and f2 symbolize the steps of the method according to the invention, where the companies S1 to Sn address the platform P and where the latter displays the boxes BA1 to BAm for sale in the store M. When an individual wishes to purchase a box and therefore acquire the shares embodied by this box, he goes to the cashier C of the store with the box, according to arrow f3. If the box is closed, he does not have access to the unique code contained therein and is therefore not able to perform the subscription procedure, and thus purchase the shares from the platform. However, if he were to open the box, he would still not be able to communicate with the platform since, to do so, it is necessary to meet a second condition related to the purchase act, i.e., the payment at the register for the price of the box, according to arrow f4. As illustrated in FIG. 2, the payment involves reading a code appearing on the box, for example a barcode, which generates the creation of a validation signal that will be sent to the platform, as symbolized by arrow f5. It is the prior reception of this validation signal of the purchase of the box that gives the buyer of the box access to the website for the subscription procedure for the shares in his box, by entering the unique code associated therewith on his computer.

FIG. 3 illustrates another method of authorizing the buyer of the box to access the site. Following the payment of the price of the box according to arrow f4, the cashier gives the buyer a document that may assume any form, which includes the access authorization information in the form of a validation code, which the buyer enters, together with the unique code of the box, to access the subscription procedure.

Of course, any other appropriate form or manner of creating a signal or validation code is covered by the invention.

According to another embodiment of the invention, the single-use “disposable” boxes Bal to Ban, rather than being directly displayed to individuals passing in front of the boxes, in the store M, could be placed in reusable outer casing boxes, which will remain the property of the store and which may be made in the form of “smart” boxes, i.e., able to be programmed and reprogrammed by the platform, regarding the price and the group of shares to be displayed by a box Ba1 to Ban. The price and the present composition of the group of shares to be acquired may be viewed on a display screen provided on the outer casing box. In this case, the second condition for access to the site of the platform could consist of opening this casing box when paying at the register.

It should be noted that instead of placing the booklet containing information about the companies and the shares relative to a box in that box, it is also possible for the person having purchased the box to obtain this information by communicating with the platform during the subscription purchase process, i.e., the purchase of the shares.

The subscription process takes place as follows: after purchasing the selected box, the buyer opens the box. He is invited to go online, to an address of the type: “www.origininvesting.com/listeentreprise”, Origin being the name of the platform. Arrow f6 symbolizes this operation. At this address, he is asked to create an identifier and a password and to enter the unique code found in his box, after having entered the validation code he received following payment, in the case of FIG. 3. For identification, he enters his contact information, such as last name, first name, proof of identity, address, bank identification information, and also completes the MIF (directive on financial instruments market) questionnaire. He then performs the subscription strictly speaking. If he accepts the group of shares as proposed, he validates the operation. If he makes another choice to distribute the amount of the price of the box, he enters the amounts that he wishes to invest in each company. After making his choice, he clicks “invest”. He is asked to electronically sign the subscription papers. After signature, he is returned to his personal area “my area” that he created beforehand by indicating his identifier and password, where he sees the list of investments that he has made. This list will indicate any change in the value of the investment, once he has purchased others later. This area also allows him to contact the platform by messaging. The investing buyer could not communicate with the platform before subscription. Conversely, the page “www.origininvesting.com/listeentreprise”, where he is asked to go by the box, includes all of the information that he may need or that could be useful for him, in particular information relative to tax benefits related to the investment in the securities, as well as the tax documentation allowing him to make the necessary declaration.

It should be noted that the computer platform offers the investor, if he wishes, combinations allowing him to invest the full amount of the box. It also offers the customer the ability to adjust the money he wishes to invest based on the price of the shares. If a balance remains, it will be placed in the account that the investor then has with the platform or, if applicable, may be reinvested in the purchase of another box or at least one individual share.

The above description of the invention shows that the latter provides companies who are not yet known or just starting out, and therefore not yet attractive due to a certain reputation, with a powerful tool to find investments, owing to the platform designed to connect companies with a large audience and individuals who are not accustomed to buying shares, but who the platform encourages to make investments through how it presents the shares, embodying them by attractive boxes at a relatively modest price. The invention is particularly appropriate for distributing unlisted shares, but may also be used for shares listed on the stock exchange.

Furthermore, due to the relatively low price of the boxes, they could be purchased by individuals wishing to invest directly in companies or to be given as gifts.

It should be noted that the term “securities” is a general expression that covers all securities, i.e., shares, bonds and the like, and also donations to companies, associations, foundations, etc. The expression “sales circuit for consumer goods” is considered to encompass sales through e-commerce sites as well. Indeed, following the customer's decision to purchase a box from among those shown on the site and payment, the customer will receive the selected box by mail or any other means, and will next perform at the subscription procedure with the platform, as described above as an example.

Of course, many changes may be made to the invention as described and shown. Thus, the physical element representative of the group of shares could also be two-dimensional, such as a card or the like. The fact that the code may be visible in this case is not problematic, since, as previously described, the subscription requires a second condition that will only be met through the payment of the price of the physical element. This second condition could be carried out in any appropriate manner It should be noted that the subscription procedure could be different from that which has been described, as long as it is based on the presence of an access code and a validation code provided through the purchase act.

1. A method for distributing securities, consisting of shares and bonds comprising:
creating a platform for distributing the securities, wherein the platform establishes groups of the securities, and
presenting each group of the securities as a physical element for sale in a sales channel for consumer goods, while ensuring that legal arrangements for purchasing securities are observed.

2. The method according to claim 1, including establishing groups of securities of more than one company.

3. The method according to claim 2, including establishing groups of securities with a financial value of no more than several hundred euros.

4. The method according to claim 1, including presenting each group of securities in the sales channel for consumer goods through a physical element selected from the group consisting of a box and an envelope identified by a unique code.

5. The method according to claim 4, wherein the physical element is a three-dimensional element inside which at least the unique identification code is located.

6. The method according to claim 5, wherein the three-dimensional element further contains a booklet that includes a description of the companies whose securities are embodied by the three-dimensional element and usage mode including an address for connecting to the platform.

7. The method according to claim 5, wherein the three-dimensional element contains at least one proposal for composition of the group of securities.

8. The method according to claim 5, wherein access to the platform opens, after entering the unique code, a subscription procedure for the securities, in order for a buyer of the three-dimensional element to confirm purchase of the securities through an electronic signature.

9. The method according to claim 8, wherein, during the subscription, the buyer must create an identifier and password and fill out a mandatory questionnaire ensuring that legal arrangements for purchasing securities are observed.

10. The method according to claim 8, wherein acquisition of the securities by the buyer of the physical element embodying the securities requires, in addition to the unique code of the physical element, an additional condition fulfilled by paying for the physical element.

11. The method according to claim 10, wherein the second condition includes sending a validation signal to the platform when paying for the physical element.

12. The method according to claim 11, wherein the second condition includes giving a validation code to the buyer of the three-dimensional element when paying for the three-dimensional element.

13. The method according to claim 1, wherein the physical element is a single-use box, made from cardboard.

14. The method according to claim 10 including a casing box containing the physical element, wherein the buyer has access to the physical element by opening the casing box when payment is made.

15. The method according to claim 14, wherein the casing box is a smart box that is programmable and reprogrammable by the platform.

16. The method according to claim 1, wherein the physical element is a two-dimensional element.

17. The method according to claim 1, wherein the securities are shares.

18. The method according to claim 1, wherein the sales channel is a big box store.

19. A system for carrying out the method according to claim 1 comprising a platform for distributing securities, suitable for establishing physical elements of securities as products able to be displayed or sold in channels and stores selling consumer goods, wherein the physical elements, and the channels and stores sell physical goods.
